(19) United States
(12) Patent Application Publication
(10) Pub. No.: US 2013/0048165 A1
(43) Pub. Date: Feb. 28, 2013

(54) Organizational Insert for Storage of Documents and Method for Production Therefor

(71) Applicant: Jose Xalabarde, Vizcaya (ES)

(72) Inventor: Jose Xalabarde, Vizcaya (ES)

(21) Appl. No.: 13/369,265

(22) Filed: Feb. 8, 2012

Related U.S. Application Data
(60) Provisional application No. 61/440,513, filed on Feb. 8, 2011.

(51) Int. Cl. A45C 1/06; B32B 37/16

(52) U.S. Cl. 150/131; 493/210

(57) ABSTRACT

The application discloses an organizational insert, comprising a plurality of overlapping flaps, for holding substantially flat items such as credit cards, papers and the like, to be built into wallets, folios or other storage articles. The organizational insert is constructed from a heat fusible textile or other material coated with a heat activated adhesive, which enables the insert to be constructed very quickly, with minimal labor costs.

### PRIORITY CLAIM

This application claims priority from provisional application No. 61/440,513

### CROSS REFERENCE TO RELATED APPLICATIONS

[N/A]

### STATEMENT REGARDING FEDERALLY SPONSORED RESEARCH OR DEVELOPMENT

[N/A]

### NAMES OF PARTIES TO JOINT RESEARCH AGREEMENTS

[N/A]

### REFERENCE TO “SEQUENCE LISTING,” TABLE, OR COMPUTER PROGRAM LISTING APPENDIX SUBMITTED ON COMPACT DISC/INCORPORATION-BY-REFERENCE OF MATERIAL ON COMPACT DISC

[N/A]

### FIELD OF THE INVENTION

The present invention relates to a device for storing credit cards, documents or other substantially flat objects in wallets, folios etc as well as a method for constructing the insert, using heat heat fusible material or other appropriate adhesive.

### BACKGROUND OF THE INVENTION

This invention relates generally to organizers, particularly wallets and folios: ie articles for holding money, credit cards, and miscellaneous standard sized flat objects. More specifically, the present invention relates to an improved organizer for storing standardized flat objects and a method for constructing said organizer. The organizer is constructed from any material with favorable strength, durability and assembly characteristics. Of particular relevance to the invention described here is the class of textiles or other flexible materials capable of being readily and permanently fused through the application of heat.

Prior to the present invention there have been a great variety of organizers, and wallet organizers that have been adapted to hold money, credit cards, checks, valuable documents, compact discs, DVD's and the like. Each of these organizers tend to provide a plurality of storage sections, pouches, or pockets to hold separate, and keep organized, the user's money, credit cards and such. One of the most ubiquitous and effective organizer modalities is a series of overlapping flaps affixed to a base layer, thereby forming pockets suitable for the storage of credit cards, drivers' license, papers, etc.

One of the problems with wallet organizers is that as as more and more items are placed into the organizer, it tends to swell to awkward proportions, making it difficult to carry the wallet or folio. Another problem, is the time it takes to construct the wallet. Normally a series of sheets are folded and fastened to form the organizer section of wallets. The sheets tend to be sewn into place by skilled workers. This process results in time consuming, and labor intensive construction which, in turn, results in inefficiency and increased production costs. This process also results in excess thickness of the empty wallet due to the thickness of the leather sheets or other material used for constructing the wallet.

Heat fusible textiles, such as woven fabrics manufactured from fibers with low melting point sheaths surrounding a high-melting-point cores, have been well received for their properties such as touch and strength. Such fibers are known as heat-fusible composite fibers and are described in various references such as U.S. Pat. No. 6,156,679 hereby incorporated by reference. Another technology applicable to the present invention is the class of heat activated adhesives that can be applied to fabric or other flexible material to allow easy joining of the material. For example, U.S. Pat. No. 4,135,033 hereby incorporated by reference, discloses a heat activated adhesive coating that enables the connection of coated materials, simply through the application of heat. Heat fusible textiles and heat activated adhesive coatings, have not been used for the construction of organizational inserts for consumer products.

Therefore, what is needed in the art is an organizer constructed from a material that keeps the wallet, folio or other consumer product as thin in cross section as possible. Keeping the thickness of the insert to a minimum would maximize storage capacity and user comfort.

Furthermore, what is needed in the art is a method of constructing an organizer for wallets, folios, etc that will reduce the cost of production by keeping the cost of raw materials as low as possible while also reducing labor costs by increasing ease and speed of assembly.

Furthermore, what is needed in the art is a substitute material that would improve the environmental impact of wallet and folio construction by moving away from animal sourced materials and toward “green” materials.

### SUMMARY OF THE INVENTION

The invention discloses a an organizing insert to be built into wallets, folios or other flat-object storage devices. The insert is constructed from a heat fusible textile or other material coated with a heat activated adhesive, which enables the insert to be constructed very quickly, with minimal labor costs. Avoiding the use of leather, other animal skins, and other bulky materials greatly reduces the cross sectional thickness of the insert, while maintaining the strength and durability of the insert, as well as products into which the insert has been incorporated.

The insert that is the subject of this application is constructed from a plurality of overlapping flaps, fused together to form pockets capable of securely holding credit cards, business cards, or other standard sized substantially flat items. The assembled insert can then be incorporated into any product used to store substantially flat, standard sized objects, such as a wallet, folio, shirt pocket, pocketbook, passport cover, ID badge holder, compact disc case, etc. The products that incorporate the insert will have improved cross sectional characteristics and reduced production costs.

### BRIEF DESCRIPTION OF THE DRAWINGS

FIG. 1: shows a ¾ open view of the insert before it has been fixed in place in a consumer product

FIG. 2 shows the side view of the insert before the flaps have been secured together or fixed in place in a consumer product.

FIG. 3 shows the top view of the insert before it has been fixed in place in a consumer product

FIG. 4 Shows a facing view of the insert before it has been fixed in place in a consumer product

FIG. 5 shows the method for constructing the insert using a heat fusible textile

FIG. 6 Shows the insert being affixed into a wallet as well as the contrast between a traditionally constructed wallet, and a wallet constructed with the insert.

### DETAILED DESCRIPTION OF THE DRAWINGS

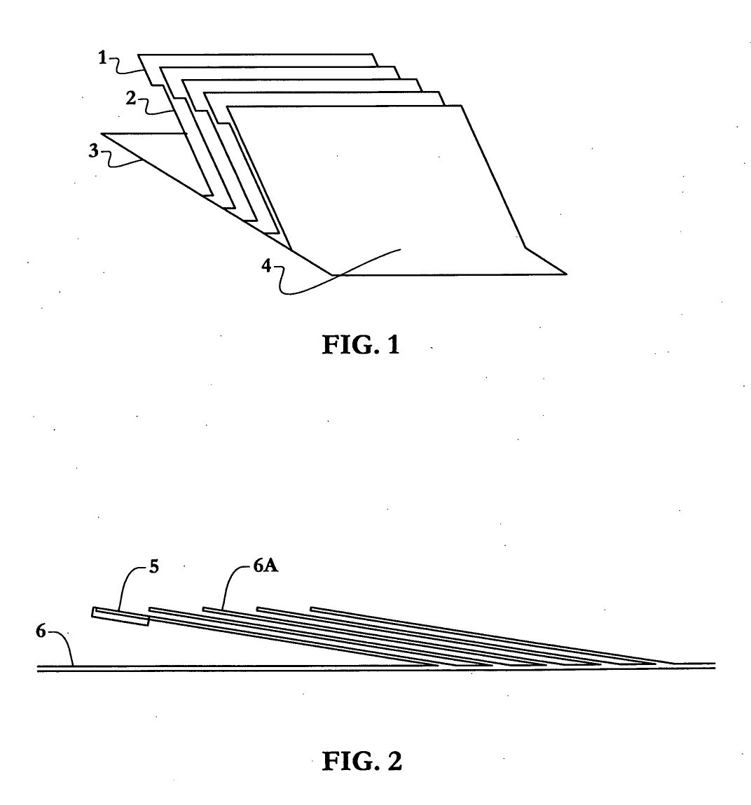

FIG. 1 shows an off-angle, exploded view of the insert before the flaps (1) have been secured to the base layer (3). The flaps here are shown with side cutouts (2). The function of the cutouts is to keep the edges of the insert as thin as possible. A front flap forms the top layer of the insert (4). Keeping material use at a minimum, keeps production costs of the insert down as well as reducing the overall thickness of the insert. A heat press is used to heat the fusible fabric causing permanent fixation.

FIG. 2 side view of the organizing insert showing one method for construction of the insert that illustrates the method of heat fusing. A base layer (6) is cut to the desired size and laid on a work surface. Additional fabric flaps are cut to the appropriate size (6A). A first flap is laid onto the base layer and fused in place by a heat source. Additional layers are placed on the base layer and fused into place, such that each flap, overlaps the prior flap and forms a new pocket.

Because the invention contemplates the use of fabrics or textiles that have less structural rigidity than traditional materials such as leather, it may be necessary to reinforce the textile in critical areas to enhance durability and wear characteristics. Shown here, the terminal edge of the textile flap is encased in a rigid sleeve (5). The sleeve could be constructed from any suitable material with the desired wear, and aesthetic characteristics, such as leather, metal, plastic, or textile. The sleeve could be fixed to the material via, sewing, gluing, crimping, heat fusing or other suitable techniques known to those skilled in the art.

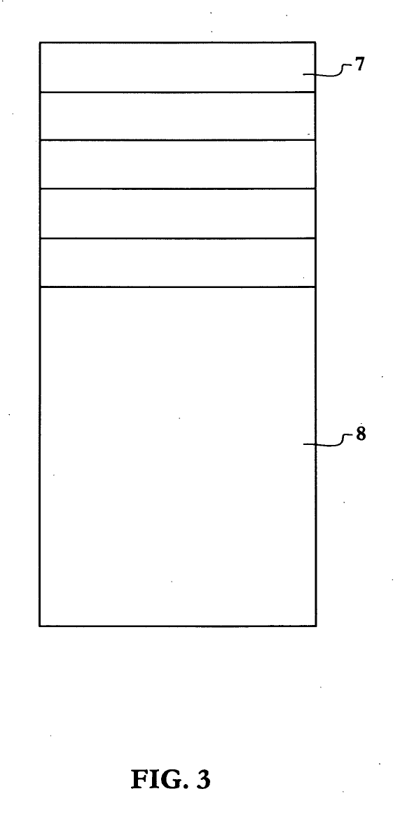

FIG. 3 shows a top view of the organizing insert. The insert (7) is generally rectangular in shape although the shape may be modified to accommodate irregularly sized or shaped items. The insert is formed by overlapping textile flaps (8), fused to a base textile layer. The overlapping flaps define pockets for holding flat objects. Depending on the size of the items sought to be stored, the flaps and base layer are cut to the appropriate size to accommodate the need. For example, inserts designed for wallets are cut to hold credit cards where inserts designed for folios are sized to form pockets that would fit standard paper sizes.

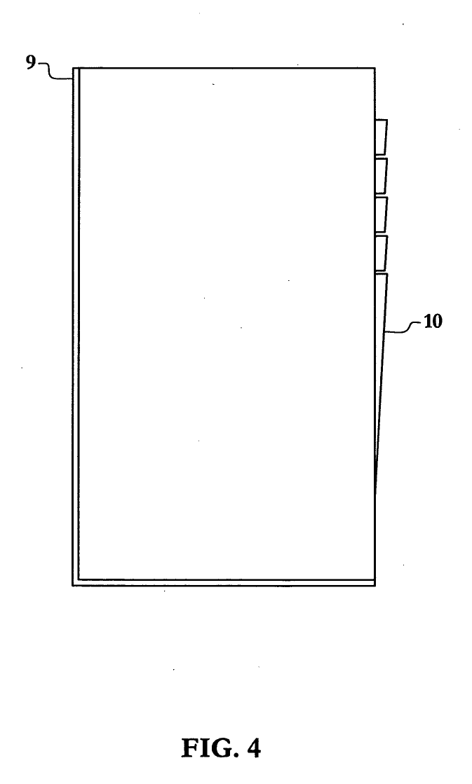

FIG. 4 Shows the facing view of the insert which demonstrates a one-piece backing layer (9,) upon which flaps have been fixed (10). The flaps are fixed in place using a heat fusible fabric or other material coated with heat activated adhesive, and a heat source. The flaps define pockets for item storage.

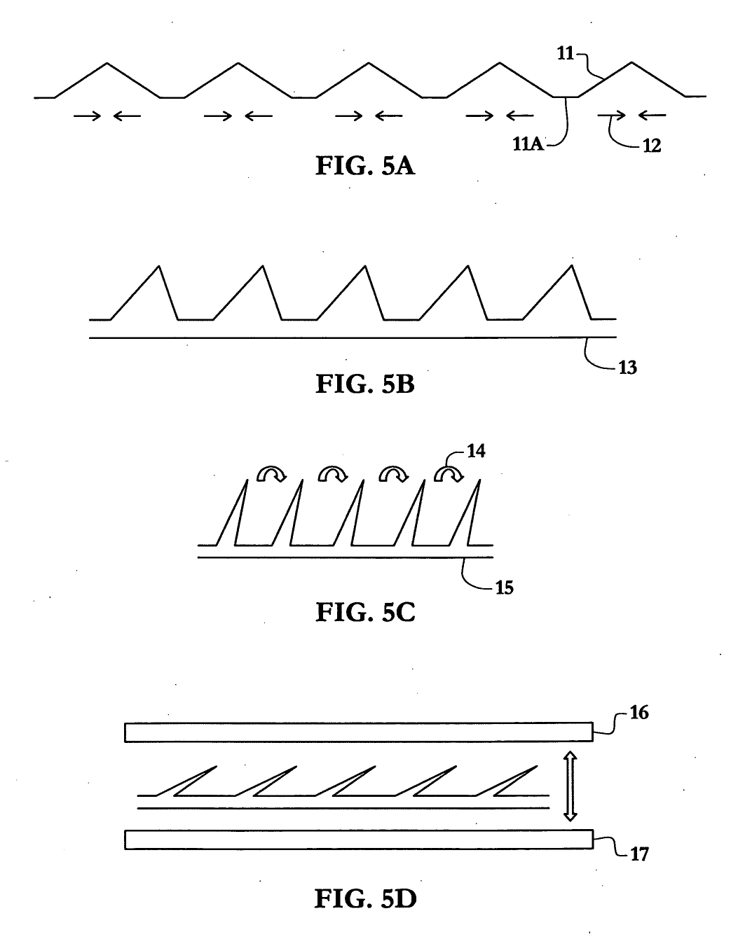

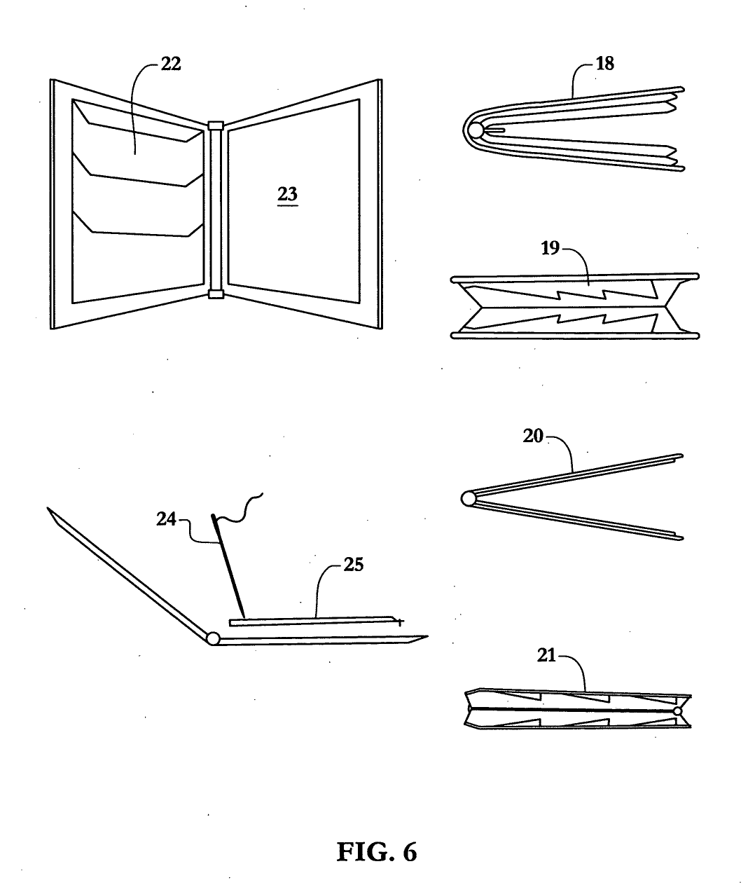

FIG. 5 demonstrates the process for making the organizational insert. A special pleating machine creates (12) folds by shrinking a layer of heat sensitive fabric (11). The fabric that is folded into pleats is coated with heat fusible glue on the side that faces the base (11A), textile layer. The base layer is also coated with heat fusible glue on the side facing the pleated layer (13). The pleating machine continues until pleats are fully formed and ready to be fused into the insert. When the pleats are ready, they are folded over (14) such that they lay flat against the base layer (15.) The base layer and the pleat layer are then sandwiched between a heat plate and a base (16). The heat plate heats the textiles to a sufficient temperature to melt the glue and bind the textile sheets together (17).

FIG. 6 shows the insert in being installed (23) and in use in a wallet (22,) although it could also be installed into a folio, pocketbook, etc. Unlike construction with leather or similar materials, the organizational insert can be fabricated separately and stockpiled for use in the construction of consumer articles. Further benefits derived from the insert include ease of attachment (24) into consumer articles due to the insert's light weight and thin cross sectional qualities. The heat fusible fabric also creates advantages in fabrication of finished consumer goods as the insert can be fixed to the product faster than inserts made from traditional materials.

Once the insert has been secured to the end product, it could be covered or disguised in some way to give the finished article a seamless appearance. For example, a leather sheet, containing appropriately placed slits, could be placed over the insert giving the finished product an all-leather look. Such a configuration would provide the dual benefit of improving the ergonomic and production aspects of the product as well as giving the luxurious feel of an all-leather product to the consumer.

FIG. 6 also demonstrates the benefits of the textile based organizational insert with respect to the thickness of the finished consumer products, as well as the characteristics of said products when in use. Wallets and folios constructed with traditional materials face several shortcomings that are overcome by the present invention. First, the use of leather or other traditional materials results in increased production costs. In order to be held securely in place, the flaps used to construct wallets and folios are typically sewn into place by human workers. This requires substantial time and labor. It also results in products that are substantially thicker in cross section than is functionally necessary.

By using the insert described in the present invention, the products created posses a much more favorable cross sectional profile (compare 18 & 19 with 20 & 21). Products incorporating the invention will also have reduced material as well as labor costs because the ease with which the textile insert can be incorporated into existing product lines will speed up production runs.

The inventor contemplates the use of the term “substantially rectangular” to include rectangular, square, polygonal, and irregularly shaped. Irregularly shaped shall include but not be limited to a rectangle with one or more of its sides comprising a curve.

The foregoing is considered as illustrative only of the principles of the invention. Further, since numerous modifications and changes will readily occur to those skilled in the art, it is not desired to limit the invention to the exact processes, components and applications shown and described, and accordingly, all suitable modifications and equivalents may be resorted to, falling within the scope of the invention and the appended claims and their equivalents. For example, while specific materials are described in the foregoing disclosure, it is not intended to limit the scope to such materials, but materials having similar properties may be substituted without limitation.

1-23. (canceled)

24. An organizational insert comprising:
a substantially rectangular base layer;
a plurality of overlapping, substantially rectangular flaps, each substantially rectangular flap further comprising;
a top edge a;
bottom edge;
a first side edge and;
a second side edge;
where the bottom edges are fastened to the base layer;
where the top edges are staggered; and
where said plurality of overlapping substantially rectangular flaps further comprise substantially rectangular cut-outs along the first and second side edges.

25. The organizational insert of claim 1 where the base layer and the plurality of substantially rectangular flaps are made from a heat fusible textile.

26. The organizational insert of claim 1 where the base layer and the plurality of substantially rectangular flaps are made from a flexible material that has been coated with a heat activated adhesive.

27. The organizational insert of claim 1 where the plurality of substantially rectangular flaps are fastened to the base layer with a heat activated glue.

28. The organizational insert of claim 1 where the base layer and the plurality of flaps are shaped to fit inside a specified region of a garment.

29. The organizational insert of claim 1 where the base layer and the plurality of flaps are shaped to fit inside a wallet.

30. The organizational insert of claim 1 where the base layer and the plurality of flaps are shaped to fit inside a portfolio.

31. The organizational insert of claim 1 where said bottom edges of the substantially rectangular flaps are fastened to said base layer through the activation of a heat fusible textile.

32. The organizational insert of claim 1 where said bottom edges of the substantially rectangular flaps are fastened to said base layer through the action of heat activated glue.

33. The organization insert of claim 1 further comprising a reinforcing member surrounding the top edges of the substantially rectangular flaps.

34. A method for making an organizational insert comprising the steps of:
forming pleats in a substantially rectangular layer of flexible material with a top surface and a facing surface;
fastening the pleated substantially rectangular layer of flexible material to a base layer.

35. The method of claim 11 where the pleated substantially rectangular layer of flexible material is comprised of a heat fusible textile and the pleated substantially rectangular layer of flexible material is fastened to the base layer by heating the heat fusible textile.

36. The method of claim 11 where the pleating step is performed using a pleating machine.

37. The method of claim 11 where the pleated substantially rectangular layer of flexible material is fastened to the base layer with a heat activated adhesive.

38. An article for the storage of substantially flat items integrating the organizational insert of claim 1.

39. The article of claim 15 where the article is a wallet.

40. The article of claim 15 where the article is a portfolio.

41. The article of claim 15 where the article is a handbag.
